(19) United States
(12) Patent Application Publication
(10) Pub. No.: US 2022/0089901 A1
(43) Pub. Date: Mar. 24, 2022

(54) CLEAR COATING COMPOSITIONS HAVING LOW SOLVENT CONTENT

(71) Applicant: Covestro LLC, Pittsburgh, PA (US)

(72) Inventors: Daniel P. Wang, Pittsburgh, PA (US); Kurt E. Best, Wexford, PA (US)

(21) Appl. No.: 17/030,875

(22) Filed: Sep. 24, 2020

(51) Int. Cl. C09D 175/06; C08G 18/76; C08G 18/73; C08G 18/60

(52) U.S. Cl. CPC C09D 175/06; C08G 18/603; C08G 18/73; C08G 18/7614

(57) ABSTRACT

A coating composition can include an aliphatic polyisocyanate having an NCO % of greater than or equal to 6 wt % to less than 22 wt % based on ISO 11909:2007 combined with a polyaspartate at an equivalent ratio of from 0.9 to 5. The coating composition can also include a metal additive in an amount of from 0.03 wt % to 0.5 wt % based on a total weight of the coating composition. The coating composition can have a total solvent content of less than or equal to 200 g/L and has an average viscosity build rate of less than 0.5 KU/min. The coating composition cures to form a coating having a haze value of less than or equal to 5 haze units based on ASTM E430-19.

### BACKGROUND

Compositions based on isocyanate chemistry find utility as components in coatings, such as, for example, paints, primers, and the like. Isocyanate-based coating compositions may include, for example, polyurethane or polyurea coatings formed from resins comprising components, such as, for example, diisocyanates, polyisocyanates, isocyanate reaction products, the like, or a combination thereof. These resins may cure by various mechanisms so that covalent bonds form between the resin components, thereby producing a cross-linked polymer network.

Environmental regulations are imposing increasingly lower volatile organic compound (VOC) limits on various coating compositions, such as architectural and industrial maintenance coatings, for example. In some jurisdictions, government regulations permit the use of “exempt solvents” that do not apply toward the VOC limit in coatings. Examples of “exempt solvents” include HFE-134, HFE-236ca12, HFE-338pcc13, H-Galden 1040X, HFE-347pcf2, HFO-1336mzz-Z, trans-1-chloro-3,3,3-trifluoroprop-1-ene, 2,3,3,3-tetrafluorpropene, 2-amino-2-methyl-1-propanol, and t-butyl acetate. In jurisdictions where the use of “exempt solvents” is permitted, they can help mitigate some of the challenges associated with coating compositions required to have increasingly lower solvent content. Such challenges can include increased viscosity, decreased pot life, etc. However, the use of “exempt solvents” is only a temporary solution and novel approaches are needed to achieve coating compositions having low VOCs without having to rely on “exempt solvents.”

### DETAILED DESCRIPTION

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

As described above, various coating compositions are subject to environmental regulations imposing increasingly stricter limits on volatile organic compounds (VOCs). While some jurisdictions allow for exempt solvents to be excluded from VOC limit requirements, this is only a temporary solution. A need remains to provide suitable coating compositions with low total solvent content. However, reducing the amount of solvents in a coating composition can affect the coating composition in a number of ways. As non-limiting examples, reducing the amount of solvents in the coating composition can increase the starting viscosity of the coating composition and the rate of viscosity build, which can both negatively impact the pot life of the coating composition, for example.

The present disclosure describes a clear coating composition with low total solvent content. For example, the clear coating composition can include an aliphatic polyisocyanate combined with a polyaspartate, where the clear coating composition includes a metal additive in an amount sufficient to extend the pot life of the clear coating composition. Additionally, the polyisocyanate can generally be over-indexed relative to the polyaspartate in an amount sufficient that the aliphatic polyisocyanate can act as a reactive diluent for the clear coating composition. Accordingly, the clear coating composition can generally be formulated to have a total solvent content of less than or equal to 200 g/L.

In further detail, the NCO content of the aliphatic polyisocyanate can generally be selected to provide both a suitable pot life for the coating composition as well as suitable properties for the final coating. For example, the NCO % of the aliphatic polyisocyanate can affect the average viscosity build rate of the coating composition. Generally, the higher the NCO % of the aliphatic polyisocyanate the faster the average viscosity build rate for the coating composition will be. As coating compositions with low solvent content generally have higher initial visocisities, polyisocyanates with higher NCO % can present some challenges in achieving a suitable pot life. In some examples, where the NCO % of the aliphatic polyisocyanate is 22 wt % or greater, the average viscosity build rate can be higher than desirable to achieve a suitable pot life for the coating composition. However, the NCO % can also affect the hardness of the resulting coating, with lower NCO % tending towards softer coatings. For example, where the NCO % of the aliphatic polyisocyanate is less than 6 wt %, the resulting coating can be softer than desirable. Thus, the aliphatic polyisocyanate can generally have an NCO % of greater than or equal to 6 wt % and less than 22 wt % based on ISO 11909:2007. In some specific examples, the aliphatic polyisocyanate can have an NCO % of from 6 wt % to 10 wt %, from 8 wt % to 12 wt %, from 10 wt % to 14 wt %, from 12 wt % to 16 wt %, or greater than or equal to 18 wt % and less than 22 wt % based on ISO 11909:2007.

Additionally, the aliphatic polyisocyanate can have a variety of number average NCO functionalities. Number average NCO functionality (Fn) can be determined via gel permeation chromatography as follows: Fn=number average molecular weight (Mn)/equivalent weight. Typically, polystyrene retention time standards can be used. With this in mind, in some examples, the aliphatic polyisocyanate can have a number average NCO functionality of from 2.3 to 3.5 based on gel permeation chromatography. In additional examples, the aliphatic polyisocyanate can have a number average NCO functionality of from 2.3 to 2.7, from 2.5 to 2.9, from 2.7 to 3.1, or from 3.1 to 3.5 based on gel permeation chromatography.

Further, the aliphatic polyisocyanate can generally have a weight average molecular weight of from 500 g/mol to 6000 g/mol based on gel permeation chromatography using polystyrene retention time standards. In some examples, the aliphatic polyisocyanate can have a weight average molecular weight of from 700 grams per mol (g/mol) to 3500 g/mol based on gel permeation chromatography. In some additional examples, the aliphatic polyisocyanate can have a weight average molecular weight of from 700 g/mol to 1500 g/mol, from 1000 g/mol to 2000 g/mol, from 1500 g/mol to 2500 g/mol, from 2000 g/mol to 3000 g/mol, or from 2500 g/mol to 3500 g/mol based on gel permeation chromatography.

A variety of aliphatic polyisocyanates, or combination of aliphatic polyisocyanates, can be included in the coating composition. As used herein, the term “polyisocyanate” refers to compounds comprising at least two un-reacted isocyanate groups. The term “diisocyanate” refers to compounds having two un-reacted isocyanate groups. Thus, “diisocyanate” is a subset of “polyisocyanate.” Polyisocyanates can include biurets, isocyanurates, uretdiones, isocyanate-functional urethanes, isocyanate-functional ureas, isocyanate-functional iminooxadiazine diones, isocyanate-functional oxadiazine diones, isocyanate-functional carbodiimides, isocyanate-functional acyl ureas, isocyanate-functional allophanates, the like, or combinations thereof.

As non-limiting examples, isocyanurates may be prepared by the cyclic trimerization of polyisocyanates. Trimerization may be performed, for example, by reacting three (3) equivalents of a polyisocyanate to produce 1 equivalent of isocyanurate ring. The three (3) equivalents of polyisocyanate may comprise three (3) equivalents of the same polyisocyanate compound, or various mixtures of two (2) or three (3) different polyisocyanate compounds. Compounds, such as, for example, phosphines, Mannich bases and tertiary amines, such as, for example, 1,4-diaza-bicyclo[2.2.2]octane, dialkyl piperazines, or the like, may be used as trimerization catalysts. Iminooxadiazines may be prepared by the asymmetric cyclic trimerization of polyisocyanates. Uretdiones may be prepared by the dimerization of a polyisocyanate. Allophanates may be prepared by the reaction of a polyisocyanate with a urethane. Biurets may be prepared via the addition of a small amount of water to two equivalents of polyisocyanate and reacting at slightly elevated temperature in the presence of a biuret catalyst. Biurets may also be prepared by the reaction of a polyisocyanate with a urea.

In some specific examples, the aliphatic polyisocyanate can include a linear aliphatic polyisocyanate. As used herein, “linear aliphatic polyisocyanate” refers to a polyisocyanate that is prepared from or based on a linear isocyanate monomer, such as 1,4-tetramethylene diisocyanate, 1,5-pentamethylene diisocyanate, or 1,6-hexamethylene diisocyanate, etc. Thus, for example, while the structure of a trimer of 1,6-hexamethylene diisocyanate may not be entirely linear, it is based on the linear monomeric 1,6-hexamethylene diisocyanate and is therefore considered a “linear aliphatic polyisocyanate” for the purposes of this disclosure. Non-limiting examples of linear aliphatic polyisocyanates can include 1,4-tetramethylene diisocyanate, 1,5-pentamethylene diisocyanate (PDI), 1,6-hexamethylene diisocyanate (HDI), a trimer of HDI, a trimer of PDI, a biuret of HDI, a biuret of PDI, an allophanate of HDI, an allophanate of PDI, an allophanate of a trimer of HDI, an allophanate of a trimer of PDI, 2,2,4-trimethyl-hexamethylene diisocyanate, 2,4,4-trimethyl-hexamethylene diisocyanate, dodecamethylene diisocyanate, 2-methyl-1,5-diisocyanatopentane, the like, or a combination thereof.

In some specific examples, the linear aliphatic polyisocyanate can be or include an HDI-based polyisocyanate. In some additional specific examples, the linear aliphatic polyisocyanate can be or include a PDI-based polyisocyanate. In some specific examples, the linear aliphatic polyisocyanate can be or include a biuret, such as a biuret of HDI, a biuret of PDI, or a combination thereof. In some additional specific examples, the linear aliphatic polyisocyanate can be or include a trimer, such as a trimer of HDI, a trimer of PDI, or a combination thereof. In still further specific examples, the linear aliphatic polyisocyanate can be or include an allophanate, such as an allophanate of HDI, an allophanate of PDI, an allophanate of a trimer of HDI, an allophanate of a trimer of PDI, or a combination thereof.

Further, in some examples, the aliphatic polyisocyanate can include a cycloaliphatic polyisocyanate. In some examples, the aliphatic polyisocyanate does not include a cycloaliphatic polyisocyanate. Where included, a variety of cycloaliphatic polyisocyanates can be included in the aliphatic polyisocyanate. Non-limiting examples can include 1-isocyanato-3,3,5-trimethyl-5-isocyanato-methylcyclohexane (IPDI), 2,4-diisocyanato-dicyclohexyl-methane, 4,4′ diisocyanato-dicyclohexyl-methane, 1-isocyanato-1-methyl-3(4)-isocyanatomethyl-cyclohexane (IMCI), 1,4-cyclohexane diisocyanate (CHDI), the like, or a combination thereof. In some specific examples, the cycloaliphatic polyisocyanate can include a secondary isocyanate group. By “secondary isocyanate group,” it is meant an isocyanate group bonded to a secondary carbon atom. In some examples, a secondary isocyanate group can increase the pot life for a corresponding coating composition due to lower reactivity as compared to a primary isocyanate group.

In some specific examples, the cycloaliphatic polyisocyanate can be or include a biuret, a trimer, an allophanate, the like, or a combination thereof. For example, in some cases, the cycloaliphatic polyisocyanate can be or include a trimer, such as a trimer of IPDI, a trimer of 2,4-diisocyanato-dicyclohexyl-methane, a trimer of 4,4′ diisocyanato-dicyclohexyl-methane, a trimer of IMCI, a trimer of CHDI, or a combination thereof. In other examples, the cycloaliphatic polyisocyanate can be or include a biuret, such as a biuret of IPDI, a biuret of 2,4-diisocyanato-dicyclohexyl-methane, a biuret of 4,4′ diisocyanato-dicyclohexyl-methane, a biuret of IMCI, a biuret of CHDI, or a combination thereof. In still additional examples, the cycloaliphatic polyisocyanate can be or include an allophanate, such as an allophanate of IPDI, an allophanate of 2,4-diisocyanato-dicyclohexyl-methane, an allophanate of 4,4′ diisocyanato-dicyclohexyl-methane, an allophanate of IMCI, an allophanate of CHDI, or a combination thereof.

Additionally, in some examples, the aliphatic polyisocyanate can include an isocyanate-terminated reaction product of an aliphatic polyisocyanate and an isocyanate-reactive material. Where this is the case, the aliphatic polyisocyanate can be or include a linear aliphatic polyisocyanate, a cycloaliphatic polyisocyanate, or a combination thereof. The linear aliphatic polyisocyanate can include one or more of the linear aliphatic polyisocyanates described elsewhere herein. Similarly, the cycloaliphatic polyisocyanate can include one or more of the cycloaliphatic polyisocyanates described elsewhere herein.

A variety of isocyanate-reactive materials can be combined with the aliphatic polyisocyanate and allowed to react to produce the isocyanate-terminated reaction product. For example, the isocyanate-reactive material can generally include a polyol or polyamine that is based on a polyether, a polyester, a polycarbonate, a polycarbonate ester, a polycaprolactone, a polybutadiene, the like, or a combination thereof. In some specific examples, the isocyanate-reactive material can include a polyether polyol. In some additional specific examples, the isocyanate-reactive material can include a polyester polyol. Additionally, the isocyanate-reactive material can generally have a number average molecular weight of from 300 g/mol to 6000 g/mol.

Examples of polyether polyols can be formed from the oxyalkylation of various polyols, for example, glycols such as ethylene glycol, 1,2- 1,3- or 1,4-butanediol, 1,6-hexanediol, and the like, or higher polyols, such as trimethylol propane, pentaerythritol and the like. One commonly utilized oxyalkylation method is by reacting a polyol with an alkylene oxide, for example, ethylene oxide or propylene oxide in the presence of a basic catalyst or a coordination catalyst such as a double-metal cyanide (DMC).

Examples of suitable polyester polyols can be prepared by the polyesterification of organic polycarboxylic acids, anhydrides thereof, or esters thereof with organic polyols. Preferably, the polycarboxylic acids and polyols are aliphatic or aromatic dibasic acids and diols.

The diols which may be employed in making the polyester include alkylene glycols, such as ethylene glycol, 1,2- 1,3- or 1,4-butanediol, neopentyl glycol and other glycols such as cyclohexane dimethanol, caprolactone diol (for example, the reaction product of caprolactone and ethylene glycol), polyether glycols, for example, poly(oxytetramethylene) glycol and the like. However, other diols of various types and, as indicated, polyols of higher functionality may also be utilized in various embodiments of the invention. Such higher polyols can include, for example, trimethylol propane, trimethylol ethane, pentaerythritol, and the like, as well as higher molecular weight polyols such as those produced by oxyalkylating low molecular weight polyols.

The acid component of the polyester can include primarily monomeric carboxylic acids, or anhydrides thereof, or esters thereof having 2 to 18 carbon atoms per molecule. Among the acids that are useful are phthalic acid, isophthalic acid, terephthalic acid, tetrahydrophthalic acid, hexahydrophthalic acid, adipic acid, succinic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid.

In addition to polyester polyols formed from polybasic acids and polyols, polycaprolactone-type polyesters can also be employed. These products are formed from the reaction of a cyclic lactone such as ε-caprolactone with a polyol containing primary hydroxyls such as those mentioned above. Such products are described in U.S. Pat. No. 3,169,949, which is incorporated herein by reference.

Suitable hydroxy-functional polycarbonate polyols may be those prepared by reacting monomeric diols (such as 1,4-butanediol, 1,6-hexanediol, di-, tri- or tetraethylene glycol, di-, tri- or tetrapropylene glycol, 3-methyl-1,5-pentanediol, 4,4′-dimethylolcyclohexane and mixtures thereof) with diaryl carbonates (such as diphenyl carbonate, dialkyl carbonates (such as dimethyl carbonate and diethyl carbonate), alkylene carbonates (such as ethylene carbonate or propylene carbonate), or phosgene. Optionally, a minor amount of higher functional, monomeric polyols, such as trimethylolpropane, glycerol or pentaerythritol, may be used.

In other examples, low molecular weight diols, triols, and higher alcohols may be included in the isocyanate-reactive material. In many embodiments, they can be monomeric and have hydroxyl values of 375 to 1810. Such materials can include aliphatic polyols, particularly alkylene polyols containing from 2 to 18 carbon atoms. Examples include ethylene glycol, 1,4-butanediol, 1,6-hexanediol, and cycloaliphatic polyols such as cyclohexane dimethanol. Examples of triols and higher alcohols include trimethylol propane and pentaerythritol. Also useful are polyols containing ether linkages such as diethylene glycol and triethylene glycol.

Thus, the aliphatic polyisocyanate can be or include a variety of aliphatic polyisocyanates, such as a linear aliphatic polyisocyanate, a cycloaliphatic polyisocyanate, an isocyanate-terminated reaction product of an aliphatic polyisocyanate and an isocyanate-reactive material, or a combination thereof. In some specific examples, the aliphatic polyisocyanate can include a blend of aliphatic polyisocyanates, such as one or more linear aliphatic polyisocyanates, one or more cycloaliphatic polyisocyanates, one or more reaction products of an aliphatic polyisocyanate and an isocyanate-reactive material, or a combination thereof. Generally, the coating composition does not include an aromatic polyisocyanate. In some examples, the polyisocyanate composition includes less than 5 wt %, less than 1 wt %, less than 0.1 wt %, or less than 0.01 wt % of an aromatic polyisocyanate.

The aliphatic polyisocyanate composition described herein can be combined with a polyaspartate to prepare a clear, low-VOC coating composition (e.g., a coating composition having less than or equal to 200 g VOCs/L of coating composition, for example). The aliphatic polyisocyanate can generally be combined with the polyaspartate composition at an equivalent ratio of from 0.9 to 5 (NCO/NH). In some additional examples, the aliphatic polyisocyanate can be combined with the polyaspartate at an equivalent ratio of from 1.1 to 3.5, from 1.2 to 3, from 1.3 to 2.6, or from 1.4 to 2.1 (NCO/NH). In some specific examples, the aliphatic polyisocyanate can be combined with the polyaspartate at an equivalent ratio of from 1.4 to 1.8 (NCO/NH).

In further detail, polyaspartates may be produced by the reaction of a polyamine with a Michael addition receptor, i.e., an olefin substituted on one or both of the olefinic carbons with an electron withdrawing group such as cyano, keto or ester (an electrophile) in a Michael addition reaction. Examples of suitable Michael addition receptors include, but are not limited to, acrylates, and diesters such as dimethyl maleate, diethyl maleate, dibutyl maleate, dimethyl fumarate, diethyl fumarate, and dibutyl fumarate.

Additionally, the polyaspartate can be prepared with a variety of polyamines, including low molecular weight diamines, high molecular weight diamines, or a combination thereof. Additionally, the polyamines can have a wide range of amine functionality, repeat unit type, distribution, etc. This wide range of molecular weight, amine functionality, repeating unit type, and distribution can provide versatility in the design of new compounds or mixtures.

Suitable low molecular weight diamines have molecular weights in various embodiments of from 60 to 400, in selected embodiments of from 60 to 300. Suitable low-molecular-weight diamines include, but are not limited to, ethylene diamine, 1,2- and 1,3-diaminopropane, 1,5-diaminopentane, 1,3-, 1,4- and 1,6-diaminohexane, 1,3-diamino-2,2-dimethyl propane, 2-methylpentamethylenediamine, isophorone diamine, 4,4′-diamino-dicyclohexyl methane, 4,4-diamino-3,3′-dimethyldicyclohexyl methane, 1,4-bis(2-amino-prop-2-yl)-cyclohexane, hydrazine, piperazine, bis(4-aminocyclohexyl)methane, and and mixtures of such diamines Representative polyaspartates prepared from these low molecular weight diamines include DESMOPHEN NH-1220, DESMOPHEN NH-1420, and DESMOPHEN NH-1520, commercially available from COVESTRO.

In some additional embodiments of the invention, a single high molecular weight polyamine may be used. Also, mixtures of high molecular weight polyamines, such as mixtures of di- and trifunctional materials and/or different molecular weight or different chemical composition materials, may be used. The term “high molecular weight” is intended to include polyamines having a molecular weight of at least 400 in various embodiments. In selected embodiments, the polyamines have a molecular weight of from 400 to 6,000. Non-limiting examples can include polyethylene glycol bis(amine), polypropylene glycol bis(2-aminopropyl ether), the like, or a combination thereof.

In some specific examples, the polyamine can be an amine-terminated polyether. Commercially available examples of amine-terminated polyethers include, for example, the JEFFAMINE series of amine-terminated polyethers from Huntsman Corp., such as, JEFFAMINE D-230, JEFFAMINE D-400, JEFFAMINE D-2000, JEFFAMINE D-4000, JEFFAMINE T-3000 and JEFFAMINE T-5000.

In some examples, the polyaspartate composition may include one or more polyaspartates corresponding to formula (I):

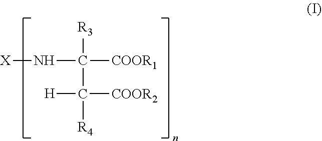

wherein:
n is an integer of at least 2;
X represents an aliphatic residue;
R₁ and R₂ independently of each other represent organic groups that are inert to isocyanate groups under reaction conditions; and
R₃ and R₄ independently of each other represent hydrogen or organic groups that are inert to isocyanate groups under reaction conditions.

In some additional examples, n has a value of from 2 to 6. In still additional examples, n has a value of from 2 to 4. In still additional examples, n has a value of 2.

In some examples, X represents an organic group that has a valency of n and is inert towards isocyanate groups at a temperature of 100° C. or less. In some additional examples, X represents a group obtained by removing amino groups from an aliphatic, araliphatic, or cycloaliphatic polyamine.

In some examples, R₁ and R₂ independently represent an alkyl group having from 1 to 9 carbon atoms. In some specific examples, R₁ and R₂ independently represent a methyl, ethyl, or butyl group. In still additional examples, R₁ and R₂, together form a cycloaliphatic or heterocyclic ring.

In some examples, the polyaspartate composition can include a blend of different polyaspartates. In other examples, the polyaspartate composition does not include a blend of different polyaspartates. Whether the polyaspartate composition includes a blend or not, the polyaspartate composition can generally have a relatively low solvent content. In some examples, the polyaspartate composition can include less than or equal to 20 wt % total solvents based on a total weight of the polyaspartate composition. In some additional examples, the polyaspartate composition can include less than or equal to 15 wt % total solvents, 12 wt % total solvents, 10 wt % total solvents, or less than or equal to 8 wt % total solvents based on a total weight of the polyaspartate composition. In some specific examples, the polyaspartate composition can be 100 wt % solids, or greater than 99 wt % solids, or greater than 95 wt % solids based on a total weight of the polyaspartate composition.

It is further noted that the aliphatic polyisocyanate, the polyaspartate composition, or a combination thereof can optionally be combined with or include one or more additives prior to mixing the aliphatic polyisocyanate and the polyaspartate composition. Non-limiting examples of additives can include a flow aid, a surfactant, a thickener, a solvent, a leveling agent, the like, or a combination thereof.

Additionally, the coating composition generally includes a metal additive to extend the pot life of the coating composition and/or decrease the hard-dry time of the coating. As used herein, “pot life” is based on a period of time during which the coating composition has a manageable viscosity. Specifically, a suitable pot life for the present coating composition can be defined as a period of time during which the coating composition has a viscosity of less than or equal to 120 Krebs units (KU) at 23° C. based on ISO 3219:2003. Thus, in some examples, the metal additive can extend the time period during which the coating composition has a viscosity of less than or equal to 120 KU at 23° C. based on ISO 3219:2003.

As described previously, in some examples, the coating composition can further include a metal additive to further increase the pot life. A variety of metal additives, including metals of various oxidation states, can be added to extend the pot life of the coating composition. In some examples, the metal additive can include a metal having a +2 oxidation state (e.g, zinc, nickel, etc.), a +3 oxidation sate (e.g., aluminum, indium, boron, cerium, etc.), a +4 oxidation state (e.g., tin, titanium, zirconium, etc.), or a +5 oxidation state (e.g., vanadium, niobium, etc.). In some specific examples, the metal additive can include a metal having a +4 oxidation state. Non-limiting examples of metals having a +4 oxidation state can include tin, titanium, manganese, zirconium, molybdenum, technetium, ruthenium, palladium, hafnium, tungsten, rhenium, osmium, iridium, platinum, cerium, or the like. In some further examples, the metal additive can be or include an organometallic compound or complex. In some examples, the metal additive can be or include an organometallic compound or complex including a metal having a +4 oxidation state, such as an organotin compound, an organotitanium compound, an organomanganese compound, an organozirconium compound, an organomolybdenum compound, an organotechnetium compound, an organoruthenium compound, an organopalladium compound, an organohafnium compound, an organotungsten compound, an organorhenium compound, an organoosmium compound, an organoiridium compound, an organoplatinum compound, an organocerium compound, the like, or a combination thereof. In other examples, the metal additive can be or include another type of chemical compound or complex including a metal having a +4 oxidation state.

In some specific examples, the metal additive can include a tin compound. A variety of tin compounds can be included in the coating composition. Non-limiting examples can be or include dibutyltin dilaurate, dimethyltin dichloride, dibutyltin dichloride, dibutyltin diacetate, stannous octoate, the like, or a combination thereof. In some specific examples, the tin compound can be or include dibutyltin dilaurate.

Where present, the tin compound can generally be included in the coating composition in an amount of from 0.01 wt % to 0.5 wt % based on a total amount of the coating composition. In some additional examples, the tin compound can be included in the coating composition in an amount of from 0.01 wt % to 0.1 wt %, from 0.05 wt % to 0.15 wt %, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

In some specific examples, the metal additive can include a titanium compound. A variety of titanium compounds can be included in the coating composition. Non-limiting examples can include tetramethyl titanium, titanium (IV) ethoxide, titanium (IV) isopropoxide, titanium (IV) butoxide, the like, or a combination thereof. In some specific examples, the titanium compound can be or include titanium (IV) isopropoxide. In other examples, the titanium compound can be or include titanium (IV) butoxide.

Where present, the titanium compound can generally be included in the coating composition in an amount of from 0.001 wt % to 0.5 wt % based on a total amount of the coating composition. In some additional examples, the titanium compound can be included in the coating composition in an amount of from 0.001 wt % to 0.01 wt %, from 0.005 wt % to 0.05 wt %, from 0.01 to 0.1, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

In some additional examples, the coating composition can include a manganese compound, a zirconium compound, a molybdenum compound, a technetium compound, a ruthenium compound, a palladium compound, a hafnium compound, a tungsten compound, a rhenium compound, an osmium compound, an iridium compound, a platinum compound, or a combination thereof. Where this is the case, the individual metal additive can generally be included in the coating composition in an amount of from 0.001 wt % to 0.5 wt % based on a total amount of the coating composition. In some additional examples, the metal additive can be individually included in the coating composition in an amount of from 0.001 wt % to 0.01 wt %, from 0.005 wt % to 0.05 wt %, from 0.01 wt % to 0.1 wt %, from 0.05 wt % to 0.15 wt %, from 0.1 wt % to 0.2 wt %, from 0.15 wt % to 0.25 wt %, from 0.2 wt % to 0.3 wt %, from 0.25 wt % to 0.35 wt %, from 0.3 wt % to 0.4 wt %, from 0.35 wt % to 0.45 wt %, or from 0.4 wt % to 0.5 wt % based on a total weight of the coating composition.

In some examples, the metal additive can be included in the polyaspartate composition prior to combining the aliphatic polyisocyanate with the polyaspartate composition. In additional examples, the metal additive can be added to the aliphatic polyisocyanate prior to combining the aliphatic polyisocyanate with the polyaspartate composition. In some additional examples, the metal additive may be added to the mixture after combination of at least some of the aliphatic polyisocyanate and the polyaspartate.

While the coating composition can include a variety of additives, the coating composition can generally be a clear coating composition. As used herein, “clear coating composition” refers to a coating composition that provides a coating having a low haze value as determined according to ASTM E430-19. Thus, in some examples, the coating composition can cure to form or provide a coating having a haze value of less than or equal to 5 haze units based on ASTM E430-19. In some additional examples, the coating composition can cure to form a coating having a haze value of less than or equal to 2 haze units based on ASTM E430-19. In still additional examples, the coating composition can cure to form a coating having a haze value of less than or equal to 1 haze unit, or less than or equal to 0.5 haze units based on ASTM E430-19.

Thus, the coating composition can either include minimal amounts of, or entirely exclude, optically opacifying agents that can increase the haze value of the coating above 5 haze units, above 2 haze units, above 1 haze unit, or above 0.5 haze units based on ASTM E430-19. In some specific examples, the coating composition does not include a pigment, or includes an amount of pigment that does not increase the haze value of the coating above 5 haze units, above 2 haze units, above 1 haze unit, or above 0.5 haze units based on ASTM E430-19.

The coating composition can generally have a total solvent content (i.e., all solvents, including exempt solvents) of less than or equal to 200 grams VOCs per liter of coating composition (g/L). In still additional examples, the coating composition can have a total solvent content of less than or equal to 180 g/L, less than or equal to 140 g/L, less than or equal to 120 g/L, or less than or equal to 100 g/L. In some further examples, the coating composition can have a total solids content of greater than or equal to 80 wt %, greater than or equal to 85 wt %, greater than or equal to 90 wt %, greater than or equal to 91 wt %, greater than or equal to 92 wt %, greater than or equal to 93 wt %, greater than or equal to 94 wt %, greater than or equal to 95 wt %, greater than or equal to 96 wt %, greater than or equal to 97 wt %, greater than or equal to 98 wt %, or greater than or equal to 99 wt % based on a total weight of the coating composition. In still additional examples, the coating composition can have a solids content of 100 wt %. In some specific examples, the coating composition can have a solids content of from 85 wt % to 95 wt %, from 91 wt % to 99 wt %, from 92 wt % to 98 wt %, or fro 93 wt % to 97 wt % based on a total weight of the coating composition.

A variety of solvents can be used to dilute the coating composition and reduce the viscosity thereof. These solvents can include exempt solvents (e.g., t-butyl acetate), non-exempt solvents, or a combination thereof. Non-limiting examples of solvents that can be employed in the coating composition can include ethyl acetate, butyl acetate, 1-methoxy propyl-acetate-2, acetone, methyl ethyl ketone, methyl isobutyl ketone, cyclohexanone, toluene, xylene, solvent naphtha, the like, or a combination thereof. In some examples, where a solvent is employed, the solvent can be added to the aliphatic polyisocyanate prior to combining the aliphatic polyisocyanate with the polyaspartate composition. In some other examples, the solvent can be added to the polyaspartate composition prior to combining the aliphatic polyisocyanate with the polyaspartate composition. In still other examples, the solvent can be added to both the aliphatic polyisocyanate and the polyaspartate composition prior to combining aliphatic polyisocyanate with the polyaspartate composition.

Depending on the aliphatic polyisocyanate and the polyasparate composition employed, the coating composition can have a variety of initial viscosities. Generally, the coating composition can have an initial viscosity of from 50 Krebs units (KU) to 75 KU at 23° C. based on ISO 3219:2003. As used herein, “initial viscosity” or Vᵢ refers to the viscosity determined according to ISO 3219:2003, generally within the first 5 minutes after initial mixing of the aliphatic polyisocyanate and the polyaspartate. In some specific examples, the coating composition can have an initial viscosity of from 50 KU to 60 KU, from 55 KU to 65 KU, from 60 KU to 70 KU, or from 65 KU to 75 KU at 23° C. based on ISO 3219:2003.

Additionally, the coating composition can generally maintain a relatively low viscosity for a sufficient amount of time to apply the coating composition to a surface. As described above, this can generally be referred to as the “pot life” of the coating composition. More specifically, a suitable pot life can generally refer to a period of time over which the coating composition has a viscosity of less than 120 KU at 23° C. based on ISO 3219:2003. With this in mind, the coating composition can generally have a viscosity of less than or equal to 120 KU at 23° C. based on ISO 3219:2003 for a period of at least 1.5 or 2 hours after initial mixing. In other examples, the coating composition can have a viscosity of less than 110 KU at 23° C. based on ISO 3219:2003 for a period of at least 1.5 or 2 hours after initial mixing. In still additional examples, the coating composition can have a viscosity of less than 105 KU or less than 100 KU at 23° C. based on ISO 3219:2003 for a period of at least 1.5 or 2 hours after initial mixing. In some specific examples, the coating composition can have a viscosity at 23° C. based on ISO 3219:2003 of from 60 KU to 100 KU at 1.5 or 2 hours after initial mixing. In some additional specific examples, the coating composition can have a viscosity at 23° C. based on ISO 3219:2003 of from 60 KU to 80 KU, from 65 KU to 85 KU, from 70 KU to 90 KU, from 75 KU to 95 KU, or from 80 KU to 100 KU at 1.5 or 2 hours after initial mixing.

In some further examples, the coating composition can be defined based on the average viscosity build rate of the coating composition. The average viscosity build rate can be determined by measuring the viscosity of the coating composition at 15-minute intervals from an initial viscosity or Vᵢ, of the coating composition up to a viscosity of 120 KU (or the highest viscosity reading within the Vᵢ, to 120 KU range) or for a period of 2 hours, whichever occurs sooner. Each of the individual viscosity build rates for the respective 15-minute intervals can then be averaged to determine the average viscosity build rate of the coating composition in KU/min. With this in mind, the coating composition can generally have an average viscosity build rate of less than 0.5 KU/min based on ISO 3219:2003. In some other examples, the coating composition can have an average viscosity build rate of less than 0.4 KU/min based on ISO 3219:2003. In still additional examples, the coating composition can have an average viscosity build rate of less than 0.3 KU/min based on ISO 3219:2003.

In some additional examples, the coating composition can dry relatively quickly to form a coating, which is referred to herein as a hard-dry time and can be determined based on ASTM D5895-03. For example, in some cases, the coating composition can have a hard-dry time of less than 8 hours, or from 1 hour to 7 hours based on ASTM D5895-03. In some additional examples, the coating composition can have a hard-dry time of from 1 hour to 3 hours, from 2 hours to 4 hours, from 3 hours to 5 hours, or from 4 hours to 6 hours based on ASTM D5895-03. Additionally, the coating composition can typically provide a coating having a pencil hardness of at least 3B, at least 1H, or at least 2H at or by the hard-dry time based on ASTM D5895-03.

The coating composition can be coated on a variety of substrates. Non-limiting examples of substrates can include metals, plastics, wood, cement, concrete, glass, the like, or a combination thereof.

The coating composition can be applied by spraying, knife coating, curtain coating, vacuum coating, rolling, pouring, dipping, spin coating, squeegeeing, brushing, squirting, printing, the like, or a combination thereof. Printing techniques can include screen, gravure, flexographic, or offset printing and also various transfer methods.

The coating composition can be applied to a substrate at a variety of coating thicknesses. For example, in some cases, the coating composition can be applied to a surface portion of a substrate at a coating thickness of from 1 thousandth of an inch (mil) to 16 mils. In other examples, the coating composition can be applied to a surface portion of a substrate at a coating thickness of from 1 mil to 5 mils, from 3 mils to 9 mils, from 6 mils to 12 mils, or from 10 mils to 16 mils.

As described previously, the coating composition can be cured to form a clear coating having a low haze value. For example, the coating composition can cure to form or provide a coating having a haze value of less than or equal to 5 haze units based on ASTM E430-19. In some additional examples, the coating composition can cure to form a coating having a haze value of less than or equal to 2 haze units based on ASTM E430-19. In still additional examples, the coating composition can cure to form a coating having a haze value of less than or equal to 1 haze unit, or 0.5 haze units ASTM E430-19.

### EXAMPLES

Materials used in the examples:

| | |
|---|---|
| Polyaspartate A | a 100% solids content aspartic ester functional amine, having |
| | an amine number of approx. 200 mg KOH/g, viscosity @ 25° C. |
| | of 1100-1500 mPa · s; |
| Polyisocyanate A | aliphatic polyisocyanate based on allophanated HDI trimer |
| | having an NCO % of 20 wt % based on ISO 11909:2007 and a |
| | number average functionality of 2.5 based on gel permeation |
| | chromatography. |
| Polyisocyanate B | aliphatic polyisocyanate based on HDI trimer having an NCO % |
| | of 19.5 wt % based on ISO 11909:2007 and a number average |
| | functionality of 4.6 based on gel permeation chromatography. |
| Polyisocyanate C | aliphatic polyisocyanate based on HDI trimer having an NCO % |
| | of 11 wt % based on ISO 11909:2007 and a number average |
| | functionality of 3.8 based on gel permeation chromatography. |
| Polyisocyanate D | aliphatic polyisocyanate based on HDI trimer having an NCO % |
| | of 22 wt % based on ISO 11909:2007 and a number average |
| | functionality of 3.5 based on gel permeation chromatography. |
| Polyisocyanate E | aliphatic polyisocyanate based on a reaction product of HDI |
| | and a polyether polyol having an NCO % of 6 wt % based on |
| | ISO 11909:2007 and a number average functionality of 4 |
| | based on gel permeation chromatography. |
| Polyisocyanate F | is a reaction product of a cycloaliphatic polyisocyanate based |
| | on IPDI and a polyether polyol having an NCO % of 4 wt % |
| | based on ISO 11909:2007 and a number average functionality |
| | of 2 based on gel permeation chromatography |
| Additive A | dibutyltin dilaurate commercially available from EVONIK |
| Additive B | titanium (IV) isopropoxide commercially available from |
| | SIGMA-ALDRICH |
| Additive C | n-butyl acetate commercially available from SIGMA- |
| | ALDRICH |
| Additive D | micronized zeolite molecular sieve powder |
| Additive E | oxazoladine moisture scavenger |

### Example 1—Over-Indexing Alone (Comparative)

Various coating compositions were prepared with Polyisocyanate A and Polyaspartate A, each of which was diluted to a total solvent content of 100 g/L with Additive C. Additionally, the polyisocyanate was over-indexed relative to the polyaspartate to help dilute the coating composition and achieve a reasonable pot-life. Specifically, the target was to achieve a pot life of less than 120 KU at 23° C. based on ISO 3219:2003 for at least a period of 2 hours and a target hard-dry time of less than 8 hours based on ASTM D5895-03. Table I presents results of the initial comparative examples.

TABLE I
Oxer-Indexing (Comparative Examples)

| | | Starting | Viscosity @ | | |
|---|---|---|---|---|---|
| | | Viscosity | 2 hours | Rate | Hard-Dry |
| Sample | Index | (KU) | (KU) | (KU/min) | Time (min) |
| 1A | 1.05 | 57.0 | Too Fast | 1.405 | 60 |
| 1B | 1.6 | 57.0 | Too Fast | 1.170 | 150 |
| 1C | 3.5 | 56.7 | 126.3 | 0.580 | >720 |

As can be seen in Table I, increasing the level at which the polyisocyanate was over-indexed relative to the polyaspartate did decrease the rate of viscosity change, but also increased the hard-dry time. Further, none of these samples achieved a pot life (i.e. viscosity of less than or equal to 120 KU at 23° C. based on ISO 3219:2003) of at least 2 hours. Thus, over-indexing alone did not achieve a coating composition with the desired performance characteristics at a total solvent content of 100 g/L.

### Example 2—Over-Indexing and Adding Metal Additive (Inventive)

All coating compositions in Example 2 were prepared by combining various polyisocyanates with Polyaspartate A at various indexes. Additionally, all coating compositions were diluted to 100 g/L total solvents using Additive C. Example 2 evaluates the effect of a metal additive on the pot life and hard-dry time of coating compositions where the polyisocyanate is over-indexed relative to the polyaspartate. Pot lifes and hard-dry times were determined as described in Example 1. As an initial comparison, Additive A was added to a coating composition equivalent to Sample 1C from Example 1. These results are presented in Table II:

TABLE II
Over-Indexing Plus Dibutyltin Dilaurate

| | | | Starting | Viscosity @ | | Hard- |
|---|---|---|---|---|---|---|
| | % | | Viscosity | 2 hours | Rate | Dry Time |
| Sample | Additive A | Index | (KU) | (KU) | (KU/min) | (min) |
| 1C | 0% | 3.5 | 56.7 | 126.3 | 0.580 | >720 |
| (Comparative) | | | | | | |
| 2A | 0.18% | 3.5 | 57.8 | 77.7 | 0.160 | 360 |

Table II makes it clear that the addition of Additive A to Sample 1C can both extend the pot life and decrease the hard-dry time of the coating composition to within more desirable ranges.

Table III presents samples where the over-indexing of the polyisocyanate relative to the polyaspartate was increased further, but with the same amount of Additive A. Additionally, the polyisocyanate content was adjusted as follows: Sample 2B—100% Polyisocyanate A, Sample 2C—70:30 Polyisocyanate A:Polyisocyanate B, and Sample 2D—70:30 Polyisocyanate A:Polyisocyanate C.

TABLE III
Polyisocyanate Blends

| | | | Starting | Viscosity @ | | Hard- |
|---|---|---|---|---|---|---|
| | % | | Viscosity | 2 hours | Rate | Dry Time |
| Sample | Additive A | Index | (KU) | (KU) | (KU/min) | (min) |
| 2B | 0.18% | 5 | 56.5 | 67.2 | 0.085 | 480 |
| 2C | 0.18% | 5 | 62.8 | 86.3 | 0.194 | 270 |
| 2D | 0.18% | 5 | 65 | 84.4 | 0.159 | 435 |

Each of samples 2B-2D had a viscosity of less than 120 KU for at least 2 hours and a hard-dry time of 8 hours or less. Additionally, while samples 2C and 2D, which included a combination of polyisocyanates, decreased the pot life to some extent, they also decreased the hard-dry time favorably.

Various coating compositions were prepared using Polyaspartate A and Polyisocyanate A at various indexes to determine the effect of Additive A at each respective index. These results are presented in Table IV.

TABLE IV
Index Comparison

| | | | Starting | Viscosity @ | | Hard- |
|---|---|---|---|---|---|---|
| | % | | Viscosity | 2 hours | Rate | Dry Time |
| Sample | Additive A | Index | (KU) | (KU) | (KU/min) | (min) |
| 2E | 0.18% | 1.1 | 57.3 | 86.1 | 0.239 | 75 |
| 2F | 0.18% | 1.6 | 57.3 | 78.0 | 0.173 | 90 |
| 2G | 0.18% | 2.1 | 57.0 | 98.0 | 0.340 | 180 |
| 2H | 0.18% | 2.6 | 57.3 | 86.6 | 0.242 | 240 |
| 2I | 0.18% | 3.1 | 57.3 | 85.1 | 0.232 | 285 |
| 2J | 0.18% | 3.5 | 57.8 | 77.7 | 0.160 | 360 |
| 2B | 0.18% | 5 | 56.5 | 67.2 | 0.085 | 480 |

Each of samples 2B and 2E-2J had a viscosity of less than 120 KU for at least 2 hours and a hard-dry time of less than or equal to 8 hours. The indexing ratio of sample 2F was chosen as a base formulation for an additional study comparing the effects of various amounts of Additive A on the pot life and hard-dry time of the corresponding coating compositions. These results are presented in Table V.

TABLE V
Tin Level Comparison

| | | | Starting | Viscosity @ | | Hard- |
|---|---|---|---|---|---|---|
| | % | | Viscosity | 2 hours | Rate | Dry Time |
| Sample | Additive A | Index | (KU) | (KU) | (KU/min) | (min) |
| 1B | 0% | 1.6 | 57.0 | Too Fast | 1.170 | 150 |
| (Comparative) | | | | | | |
| 2K | 0.045% | 1.6 | 57.0 | 73.0 | 0.134 | 195 |
| 2L | 0.09% | 1.6 | 57.3 | 75.8 | 0.153 | 120 |
| 2F | 0.18% | 1.6 | 57.3 | 78.0 | 0.173 | 90 |
| 2M | 0.27% | 1.6 | 57.0 | 79.5 | 0.190 | 105 |

Once again, each of formulations 2F and 2K-2M had a viscosity of less than 120 KU for at least 2 hours and a hard-dry time of less than or equal to 8 hours. As one additional comparison, sample 2M was compared against a coating composition including Additive B (titanium compound) instead of Additive A (tin compound). The results of this study are presented in Table VI.

TABLE VI
Metal Additive Comparison

| | | | | Starting | Viscosity @ | | Hard- |
|---|---|---|---|---|---|---|---|
| | % | % | | Viscosity | 2 hours | Rate | Dry Time |
| Sample | Additive A | Additive B | Index | (KU) | (KU) | (KU/min) | (min) |
| 2M | 0.27% | 0% | 1.6 | 57.0 | 79.5 | 0.190 | 105 |
| 2N | 0% | 0.3% | 1.6 | 56.2 | 61.1 | 0.041 | 90 |

Sample 2N had a lower viscosity at 2 hours and a shorter hard-dry time than Sample 2M. Thus, various metal additives can be used to achieve a coating composition having a total solvent content of 100 g/L with a pot life of at least 2 hours and a hard-dry time of less than 8 hours.

### Example 3—Effect of NCO % on Pot Life

Various coating compositions were prepared using aliphatic polyisocyanates having differing NCO % contents to determine what effect this may have on the coating compositions. Coating compositions were prepared by combining the various aliphatic polyisocyanates with Polyaspartate A at NCO/NH indexes of 1.1. and 1.6 as a comparison. Each of the coating compositions was prepared at a total solvents content of 100 g/L using Additive C as diluent. Additionally, each of the coating compositions was prepared with 0.2 wt % Additive A. The NCO % of each composition was compared with the average rate of viscosity change (KU/min) based on ISO 3219:2003 for the respective coating compositions. The average rate of viscosity change was calculated by collecting individual viscosity readings every 15 minutes from an initial viscosity (Vᵢ) through a viscosity of 120 KU (or the highest reading within the Vᵢ, to 120 KU range) for each respective coating composition. The individual viscosity rates for each 15-minute interval were averaged to determine the average viscosity rate for the each respective coating composition. The results of four representative examples are presented in Table VII.

TABLE VII
Effect of NCO % on Average Viscosity Rate

Average Viscosity Rate (KU/min)

| Polyisocyanate | NCO % | Index 1.1 | Index 1.6 |
|---|---|---|---|
| F | 4 | 0.168 | 0.133 |
| E | 6 | 0.290 | 0.223 |
| A | 20 | 0.360 | 0.269 |
| D | 22 | 0.611 | 0.573 |

As can be seen from the results in Table VII, the greater the NCO % of the polyisocyanate, the greater the average viscosity rate of the coating composition. In particular, for a 100 g/L coating composition, coating compositions prepared with an NCO % of 22 wt % or greater resulted in an average viscosity build rate of greater than 0.5 KU/min and a shorter than desirable pot life.

Lower NCO % provided favorable pot lifes of less than 120 KU at 23° C. based on ISO 3219:2003 for at least a period of 2 hours. However, where the NCO % contents were below 6 wt %, the coating compositions generally resulting in a final coating that was softer than desired (data not shown).

Thus, the polyisocyanate can generally have an NCO % of greater than or equal to 6 wt % and less than 22 wt % to provide a suitable coating composition with respect to average viscosity build rate and final hardness of the resulting coating.

### Example 4—Coating Compositions with Drying Agents

Various clear coating compositions were prepared by combining Polyisocyanate A and Polyaspartate A at an equivalent ratio of 1.6. The coating compositions were diluted with Additive C to achieve 100 g VOCs per liter of coating composition. Drying agents were included in the clear coating compositions to determine whether additional pot life could be achieved as compared to coating compositions without the drying agents. The formulation for each of the coating compositions is presented in Table VIII.

TABLE VIII
Coating Compositions with Drying Agents

| | % | % | % | % | |
|---|---|---|---|---|---|
| Sample | Additive A | AdditiveB | Additive D | Additive E | Index |
| 4A | 0 | 0 | 0 | 0 | 1.6 |
| 4B | 0.027 | 0.003 | 0 | 0 | 1.6 |
| 4C | 0.027 | 0.003 | 2 | 0 | 1.6 |
| 4D | 0.027 | 0.003 | 0 | 4 | 1.6 |
| 4E | 0.027 | 0.003 | 0 | 6 | 1.6 |
| 4F | 0 | 0 | 2 | 0 | 1.6 |
| 4G | 0 | 0 | 0 | 4 | 1.6 |
| 4F | 0 | 0 | 0 | 6 | 1.6 |

Each of the coating compositions presented in Table VIII were evaluated to determine pot life and hard-dry time. Pot life and hard-dry time were measured as described previously. Additionally, because the coating compositions are intended to be clear, the haze of each formulation based on ASTM E340-19 was also measured to determine any adverse effects of the drying agent on the clarity of the formulation. The results of these evaluations are presented in Table IX.

TABLE IX
Effect of Drying Agents on Clear Coating Compositions.

| | Starting | Viscosity @ | | | |
|---|---|---|---|---|---|
| | Viscosity | 2 hours | Rate | Hard-Dry | |
| Sample | (KU) | (KU) | (KU/min) | Time (min) | Haze |
| 4A | 57 | >140 | 1.170 | 2.5 | 0 |
| 4B | 57 | 72.8 | 0.132 | 2 | 0 |
| 4C | 57.3 | 62.8 | 0.045 | 3 | 23 |
| 4D | 56.7 | 82 | 0.211 | 3.5 | 0 |
| 4E | 55.6 | 72.2 | 0.139 | 6 | 0 |
| 4F | 57.3 | 124.7 | 0.553 | 3.75 | 25.2 |
| 4G | 56.2 | >140 | 1.442 | 12 | 0 |
| 4F | 55.6 | >140 | 1.423 | 12 | 0 |

As can be seen from Table IX, all of the formulations excluding Additives A and B had poor pot life, while all formulations including Additives A and B had acceptable pot life. Additive D improved the pot life as compared to compositions without Additive D, but caused the coating compositions to become hazy. Additive E generally decreased the pot life and increased the hard-dry time as compared to compositions without Additive E. The outcomes of Additive D and Additive E were both considered undesirable for the present formulations. However, Additive E did not adversely affect the clarity of the formulations like Additive D.

It should be understood that the above-described examples are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. A coating composition, comprising:
an aliphatic polyisocyanate having an NCO % of greater than or equal to 6 wt % and less than 22 wt % based on ISO 11909:2007 combined with a polyaspartate at an equivalent ratio of from 0.9 to 5; and
a metal additive in an amount of from 0.03 wt % to 0.5 wt % based on a total weight of the coating composition,
wherein the coating composition has a total solvent content of less than or equal to 200 g/L, wherein the coating composition has an average viscosity build rate of less than 0.5 KU/min based on based on ISO 3219:2003, and wherein the coating composition cures to form a coating having a haze value of less than or equal to 5 haze units based on ASTM E430-19.

2. The coating composition of claim 1, wherein the aliphatic polyisocyanate comprises an allophanate.

3. The coating composition of claim 1, wherein the aliphatic polyisocyanate comprises an HDI-based polyisocyanate, a PDI-based polyisocyanate, or a combination thereof.

4. The coating composition of claim 1, wherein the aliphatic polyisocyanate comprises a blend of aliphatic polyisocyanates.

5. The coating composition of claim 1, wherein the aliphatic polyisocyanate has a number average NCO functionality of from 2.3 to 3.5 based on gel permeation chromatography.

6. The coating composition of claim 1, wherein the polyaspartate comprises a blend of polyaspartates.

7. The coating composition of claim 1, wherein the aliphatic polyisocyanate and the polyaspartate are combined at an equivalent ratio of from 0.9 to 2.1.

8. The coating composition of claim 1, wherein the metal additive comprises a tin compound, a titanium compound, or a combination thereof.

9. The coating composition of claim 1, wherein the coating composition has an initial viscosity of from 50 KU to 75 KU at 23° C. based on ISO 3219:2003.

10. The coating composition of claim 1, wherein the coating composition has a viscosity at 23° C. based on ISO 3219:2003 of 120 KU or less for at least 1.5 hours after mixing.

11. The coating composition of claim 1, wherein the coating composition has a solids content of from 91 wt % to 99 wt % based on a total weight of the coating composition.

12. A coated substrate, comprising:
a substrate having the coating composition of claim 1 applied to surface portion thereof, wherein the coating composition is cured to form a coating having a haze value of less than or equal to 5 haze units based on ASTM E430-19.

13. The coated substrate of claim 12, wherein the substrate comprises metal, plastic, wood, cement, concrete, glass, or a combination thereof.

14. The coated substrate of claim 12, wherein the coating composition is applied at a coating thickness of from 1 mil to 16 mils.

15. The coated substrate of claim 12, wherein the coating composition has a hard-dry time of from 1 hour to 8 hours based on ASTM D5895-03.

16. A method of making a coating composition, comprising:
combining an aliphatic polyisocyanate having an NCO % of greater than or equal to 6 wt % and less than 22 wt % based on ISO 11909:2007 with a polyaspartate at an equivalent ratio of from 0.9 to 5 to form a reaction mixture; and
adding a metal additive to the reaction mixture to form the coating composition,
wherein the coating composition has a total solvent content of less than or equal to 200 g/L, wherein the coating composition has an average viscosity build rate of less than 0.5 KU/min based on ISO 3219:2003, and wherein the coating composition cures to form a coating having a haze value of less than or equal to 5 haze units based on ASTM E430-19.

17. The method of claim 16, wherein the aliphatic polyisocyanate is diluted with solvent prior to combining with the polyaspartate.

18. The method of claim 16, wherein the polyaspartate is diluted with solvent prior to combining with the aliphatic polyisocyanate.

19. The method of claim 16, wherein the metal additive is combined with the polyaspartate prior to combining the polyaspartate with the polyisocyanate.

20. The method of claim 16, wherein the coating composition has a viscosity of less than or equal to 120 KU at 23° C. based on ISO 3219:2003 for a period of at least 1.5 hours after mixing.
